(19) United States
(12) Patent Application Publication
(10) Pub. No.: US 2008/0226809 A1
(43) Pub. Date: Sep. 18, 2008

(54) Method of Solidifying Sugar Solutions Obtained from Grapes and From Must Applied Processes, Concentrated Rectified Must, Concentrated Rectified Juice and Transformation Products of Vegetable Origin and Their Derivatives

(76) Inventor: Luigi Pirrone, Palermo (IT)

Correspondence Address: YOUNG & THOMPSON, 209 Madison Street, Suite 500, ALEXANDRIA, VA, 22314, US

(21) Appl. No.: 12/092,419

(22) PCT Filed: Nov. 3, 2005
(86) PCT No.: PCT/IT05/00639

§ 371 Date: Jun. 1, 2008

(51) Int. Cl. A23L 1/28; A23L 1/212

(52) U.S. Cl. 426/655

(57) ABSTRACT

A method of solidifying particularly sugar solutions from grape processing that can also be used for the production of concentrated, rectified must (CRM) is characterized in that the step of solidification is carried out by leading the sugar solution to a sugar concentration which is suitable for the solidification of their components able to be solidified from 50% by weight of sugars to the maximum value of the obtainable concentration.

A solidified sugar product is obtained that can also be separated from the not solidified components and offers a number of advantages regarding both package and use as well as storage and transportation.

The present invention relates to a method of solidifying a sugar solution that can be used for producing concentrated, rectified must from grape processing after removing most constituent elements of the raw material except for sugars by processing technologies.

More generally, the method of the invention can be used for solidifying concentrated, rectified must, concentrated, rectified juice, and all sugar solutions of vegetable origin treated as mentioned above.

As known, the concentrated, rectified must (CRM) is a product from grape must subjected to rectification by ion exchanging resins and then to concentration in multistage evaporators.

The product obtained is at a thick liquid state under room temperature with a transparent, limpid, somewhat purified, white colour consisting of a water solution essentially of glucose and fructose with a concentration equal to about 68% by weight, and minor components the limit parameters of which are fixed by law according to CEE Regulations No. 8822/87 and No. 2253/88.

CRM is used for enriching must from white and red grapes produced in regions where the pedoclimatic conditions do not allow the desired sugar content to be reached, and finds wide application in wine-making field for sweetening and preparation of sparkling wine and champagne-type wine as well as in food industry, pastry-making confectionery, and bakery.

CRM produced in factory is transported to the users according to destination by means of tank lorries, tankers and container trucks, the loading and unloading of which are carried out by means of suitable pumps, each tank lorry being able to carry even 300 quintals, for example.

CRM as produced at the liquid state causes some problems during storage, transportation and use, which is a limiting factor for its wider expansion to the users with the consequence of a reduced demand that is slow in increasing.

For example, during storage where CRM is stored in suitable silos of stainless steel as well as during production and use, one main problem consists in that the product is susceptible to spontaneous, even reduced crystallization caused by a decrease in the temperature due to climatic variability, with the result of a decrease in the sugar content that causes difficulties in its use.

In fact the concentration of glucose and fructose in the final product almost never exceeds 68-70% by weight just to avoid such problem.

Furthermore, the product at the liquid state during production, transportation and use has to be stored in suitable silos with a variable size and transferred by means of pumps, pipelines, and other equipments not always available by the user because of the high operating costs.

The object of the invention is in particular to solidify sugar solutions from grape processing that can also be used to produce concentrated, rectified must in order to provide a solidified product—even of the doughy type—that does not cause, among others, the problems mentioned above. In particular, an object of the invention is the set-up of a method of producing a solidified sugar product that offers a number of advantages regarding both package and use as well as storage and transportation.

The above object is reached by providing a method for solidifying sugar solutions even for the production of CMR including a step of solidification of the components of the solution containing glucose and fructose and minor constituents to form a solidified product that can be separated, if necessary, from the not solidified components.

A not limiting description of an embodiment of the invention will follow for a better understanding thereof.

According to the present invention, the step of solidification is carried out by leading the sugar solution to such a sugar concentration as to cause the solidification of glucose and fructose and minor constituents to form a product to be subjected, if necessary, to suitable treatments for its use.

Therefore, the invention relates to a method of solidifying particularly sugar solutions from grapes that can also be used for the production of CRM (Concentrated, Rectified Must), characterized by reaching a concentration from 50% to the maximum value of the obtainable concentration, preferably greater than 68% by weight of sugars which is suitable for the solidification of the solidifiable components included in the used raw material.

The step of solidification mentioned above can be carried out by concentrating the sugar solution used also in association with or upon treatment by one or more hydrophilic agents and simultaneously or upon use of systems and processing steps that are not mentioned by the sake of simplicity but can allow the solidifiable components of the sugar solution to be solidified.

Furthermore, the above step of solidification can also be carried out at higher or lower sugar concentrations than that mentioned in the embodiment explained thereafter with or without insemination, and possibly with simultaneous or following purification of the product obtained by using suitable systems at a purity and drying degree which is a function of the desired product.

The invention can be extended in its application to the solidification of concentrated, rectified must, concentrated, rectified juice, and rectified or not, even not concentrated transformation products from raw materials of vegetable origin, and their derivatives.

The method of the invention is described in a not limiting embodiment in which other details are described for further explanation of the present invention.

An amount of sugar solution from grape processing subjected to treatment for removing components from the solution except for the sugars for the possible production even of concentrated, rectified must is concentrated at a greater concentration than 68%, particularly about 82% by weight of sugars. After leaving to rest the solution for some time the solidification of the solidifiable products of the starting sugar solution is obtained.

It is evident that the preceding embodiment illustrated by way of a not limiting example directed to show the validity of the invention sets aside the theoretical and practical values of the method for the maximum yield and economic advantages such as concentrations of the starting sugar solution, maximum concentration that can be reached during processing, temperature, vacuum, and other variables.

There is provided a following possible centrifugation step to separate the solidified product from the liquid solution destined to other application, then a possible purification step by washing with suitable liquids, for example water, or by using washing solutions for other purposes, and at last an evaporation step of the residual liquid impregnating the solidified product to be destined to other applications.

Thus a solidified product is obtained with a more or less high drying degree with respect to the different types of solidified products to be subjected, if necessary, also to suitable treatment to provide the desired granulometry of the final product destined to different types of packaging.

1. A method of solidifying sugar solutions, including the doughy form, from grape processing obtained after removing constituent elements of the raw material except for sugars, characterized in that the step of solidification is carried out by leading the sugar solution to a sugar concentration which is suitable for the solidification of their components able to be solidified from 50% by weight of sugars to the maximum value of the obtainable concentration.

2. The method of solidifying sugar solutions according to claim 1, characterized in that the concentration of glucose and fructose to be reached during the process is greater than 68% by weight of sugars.

3. The method of solidifying sugar solutions according to claim 1, characterized in that the solidification is carried out by using the sugar solution alone.

4. The method of solidifying sugar solutions according to claim 1, characterized in that the solidification is carried out by using the sugar solution in association with one or more hydrophilic agents.

5. The method of solidifying sugar solutions according to claim 1, characterized in that the solidification is carried out by using the sugar solution with substances able to help the solidification of the solution.

6. The method of solidifying sugar solutions according to claim 1, characterized in that the sugar solution can be subjected in advance to rectification processes.

7. The method of solidifying sugar solutions according to claim 1, characterized in that the solidification step is carried out with or without insemination in suitable systems or process steps.

8. The method of solidifying sugar solutions according to claim 1, characterized in that there are provided the following steps:
a) separation of the solidified product from the not solidified components, and
b) purification and drying of the solidified product.

9. The method of solidifying sugar solutions according to claim 8, characterized in that the separation of the solidified product from the not solidified product is carried out at the same time as the solidification.

10. The method of solidifying sugar solutions according to claim 8, characterized in that the separation of the solidified product from the not solidified product is carried out after the solidification.

11. The method of solidifying sugar solutions according to claim 8, characterized in that the purification and drying of the solidified product are followed by a suitable treatment to provide the desired granulometry of the final product destined to different types of packaging.

12. The method according to claim 1, wherein the starting sugar solution has a varying concentration of glucose and fructose.

13. The method according to claim 1, characterized in that the solidified product is provided for different granulometry and packaging.

14. The method according to claim 1, characterized in that it is applicable to concentrated, rectified must.

15. The method according to claim 1, characterized in that it is applicable to concentrated, rectified juice and rectified, even not concentrated juice.

16. The method according to claim 1, characterized in that it is applicable to rectified and not, even not concentrated transformation products of raw materials of vegetable origin and their derivatives.
